(19) United States
(12) Patent Application Publication
(10) Pub. No.: US 2026/0189590 A1
(43) Pub. Date: Jul. 2, 2026

(54) GRAYWARE WEBSITE DETECTION WITH TRANSFER LEARNING

(71) Applicant: Palo Alto Networks, Inc., Santa Clara, CA (US)

(72) Inventors: Shehroze Farooqi, Santa Clara, CA (US); Ritika Singhal, San Jose, CA (US); Shan Huang, San Jose, CA (US); Grace Sally Lam, Mountain View, CA (US); William Russell Melicher, Sunnyvale, CA (US); William Redington Hewlett, II, Mountain View, CA (US); Oleksii Starov, Sunnyvale, CA (US); Brody James Kutt, Irvine, CA (US)

(21) Appl. No.: 19/005,788

(22) Filed: Dec. 30, 2024

(51) Int. Cl. H04L 9/40; G06N 3/045; H04L 41/16

(52) U.S. Cl. CPC H04L 63/1433; G06N 3/045; H04L 41/16

(57) ABSTRACT

A model trainer obtains initial training data and refined training data to be used for training a classification model to detect grayware in Hypertext Markup Language (HTML) documents using transfer learning. The model trainer obtains the refined training data by collecting grayware HTML documents from a trusted data source(s), embedding and clustering the grayware HTML documents, and identifying and removing clusters having low confidence of corresponding to known grayware campaigns. The model trainer then trains a baseline model to classify HTML documents as grayware or benign with the initial training data, replaces the classification head of the baseline model with a new classification head to obtain a refined model, and further trains via the refined model via transfer learning with the refined training data.

### BACKGROUND

The disclosure generally relates to data processing and computing arrangements based on computational models (e.g., CPC subclass G06N and CPC subclass G06F 16/00).

Grayware refers to websites that may not directly pose a security threat but nonetheless may display obtrusive behavior such as attempting to dupe users into granting remote access and/or downloading/running potentially unwanted programs (PUP), files, etc. Grayware often leverages high popularity topics to engineer websites that resemble trusted websites, for instance by mimicking trusted news websites reporting on trending stories, by mimicking installation portals for well-known software, etc. Although grayware may not directly pose a security threat, it can open attack vectors for more serious attacks by other malicious actors.

### BRIEF DESCRIPTION OF THE DRAWINGS

Embodiments of the disclosure may be better understood by referencing the accompanying drawings.

FIG. 1 is a schematic diagram of an example system for collecting and labeling initial training data and refined training data for training classification models to detect grayware.

FIG. 2 is a schematic diagram of an example system for training a grayware classification model with transfer learning and initial and refined training data.

FIG. 3 is a schematic diagram of an example model architecture for a grayware classification model.

FIG. 4 is a flowchart of example operations for generating initial and refined training data and training a machine learning model to classify grayware with transfer learning on the initial and refined training data.

FIG. 5 is a flowchart of example operations for classifying Hypertext Markup Language (HTML) documents as grayware or benign with a trained classification ensemble.

FIG. 6 depicts an example computer system with a model trainer, a baseline grayware classification model, a refined grayware classification model, and a clustering model.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Grayware campaigns are constantly evolving according to the diverse landscape of social trends, viral/popular topics, etc. Moreover, grayware often involves natural language that may not appear malicious. As a result, traditional phishing or malware detection techniques are ineffective for grayware detection, and grayware website labels are unreliable. To illustrate, in malware detection the goal is typically to detect malicious payloads such as executables, and in phishing detection the goal is typically to detect brand impersonation. By contrast, grayware is not likely to be performing either of these malicious actions, and instead utilizes more content-centric techniques to create a sense of urgency, make false promises, offer fake gifts, exploit trending opportunities to deceive users, etc. As a result, grayware detection can be challenging and there is a short supply of high-quality training data (i.e., accurately labeled training data) for training grayware classification models. The content-centric nature of grayware motivates the use of Hypertext Markup Language (HTML) documents and structure for grayware detection.

The present disclosure proposes refining training data of grayware classification models and overcoming the limited amount of training data with transfer learning using the refined training data. Prior to training, a model trainer collects initial training data comprising HTML documents and corresponding grayware or benign labels from initial data sources. The initial training data is high volume but less likely to correspond to have accurate labels. The model trainer then collects additional HTML documents from trusted data sources having a higher likelihood of corresponding to grayware. The model trainer generates embeddings for the additional HTML documents labeled as grayware and clusters these embeddings. Each cluster is inspected, and clusters that are not associated with known grayware are discarded resulting in higher quality refined training data.

The model trainer trains a classification model to classify HTML documents as grayware or benign using transfer learning. First, the model trainer trains the classification model on the initial training data, then replaces the classification head of the classification model. Subsequently, the model trainer further trains the classification model on the refined training data. There may not be enough refined training data to adequately train the classification model for grayware classification, so the use of transfer learning with both the initial training data and the refined training data ensures that the classification model is adequately trained while also being trained on high-quality training data. Moreover, the refinement of the initial training data via clustering resolves issues with collecting high-quality grayware or benign labeled samples in the wild.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

“Grayware” refers to a classification of a website and/or content (e.g. HTML documents) associated with that website that indicates that the website displays or otherwise provides content that may not pose a direct security threat but that exhibits other intrusive behavior and may attempt to dupe users into granting remote access or performing other authorized actions, such as downloading files or extensions.

### Example Illustrations

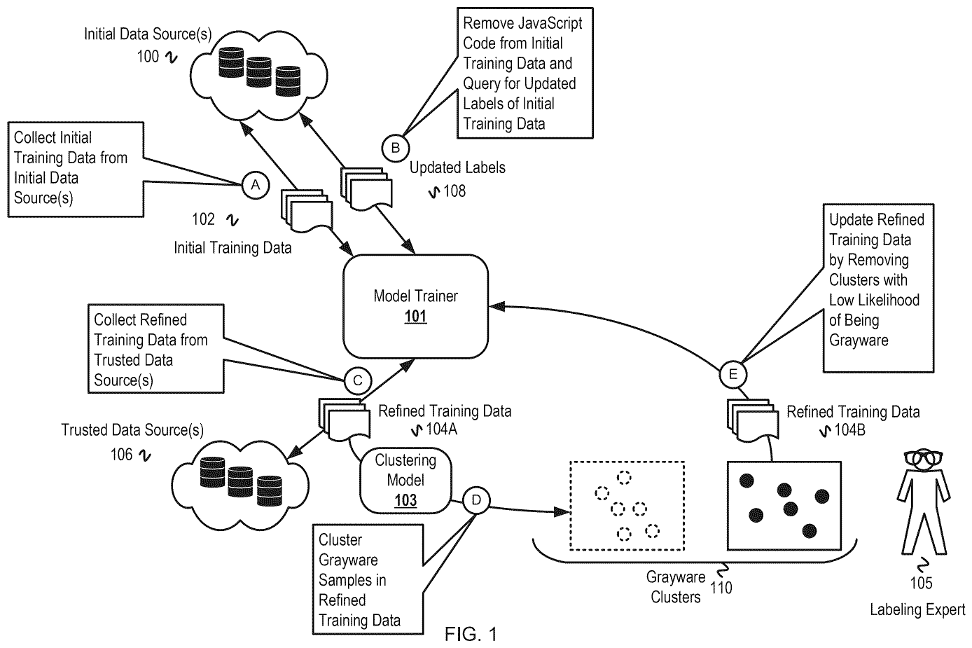

FIG. 1 is a schematic diagram of an example system for collecting and labeling initial training data and refined training data for training classification models to detect grayware. A model trainer 101 collects initial training data 102 comprising HTML documents from an initial data source(s) 100, removes JavaScript® code from the initial training data 102, and obtains updated labels 108 for the initial training data 102 with the JavaScript code removed. The model trainer 101 then collects refined training data 104A also comprising HTML documents from a trusted data source(s) 106. A clustering model 103 clusters the refined training data 104A and removes clusters having low likelihood of corresponding to grayware to obtain refined training data 104B.

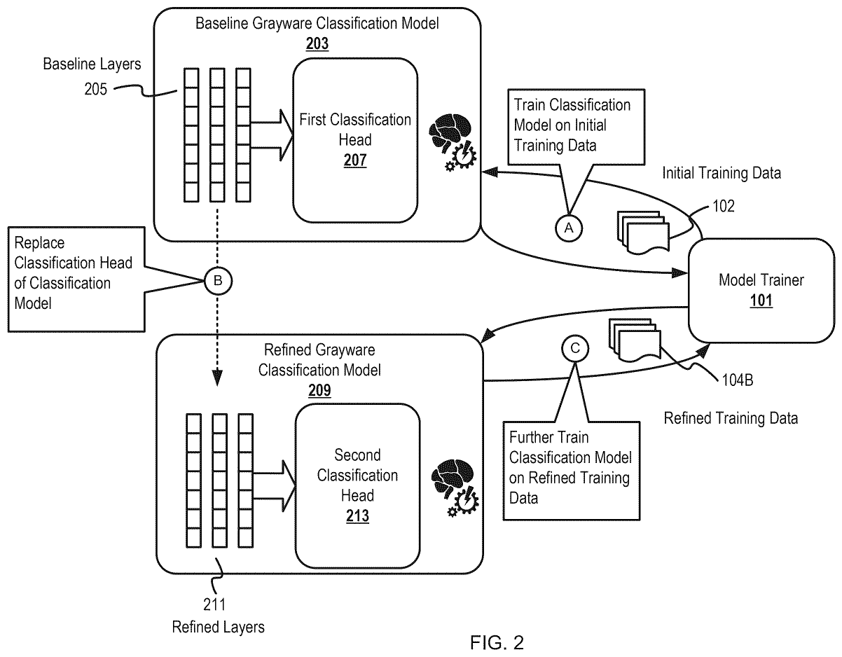

FIGS. 1 and 2 are annotated with a series of letters A-E and a series of letters A-C, respectively, representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

Referring now to FIG. 1, at stage A, the model trainer 101 collects the initial training data 102 from the initial data source(s) 100 (depicted in FIG. 1 as being accessed via the cloud). For instance, the model trainer 101 can comprise a web crawler (not depicted) that crawls the Internet for the initial training data 102. The web crawler can be a component in a cybersecurity system that crawls the Internet for Hypertext Transfer Protocol (HTTP) responses from websites and obtains malicious or benign verdicts for the websites using the HTTP responses, wherein the malicious verdicts are then used for Uniform Resource Locator (URL) filtering when managing cybersecurity of an organization. Each sample in the initial training data 102 comprises one or more HTML documents for corresponding websites. Benign samples (i.e., benign HTML documents) in the initial training data 102 can be collected by the model trainer 101 from popular websites using a service that ranks most popular domains, because popular domains are less likely to correspond to malware. For instance, the model trainer 101 can collect benign samples from top (e.g., top 1 million) websites according to the Tranco list of websites, which ranks the most popular domains on the Internet that are more likely to be benign due to their popularity. Benign samples can additionally be collected from trusted customer websites. Benign samples in the initial training data 102 are also subsequently used when collecting/labelling the refined training data 104A, 104B.

At stage B, the model trainer 101 removes JavaScript code from the initial training data 102 (e.g., by removing code included in script HTML tags) and queries the initial data source(s) 100 for the updated labels 108 using the initial training data 102 with the JavaScript code removed. For instance, the model trainer 101 can query a third-party service (e.g., the VirusTotal® scan service) with HTML documents in the initial training data 102 to obtain the updated labels 108. For the purposes of labeling the initial training data 102, the model trainer 101 treats a malicious or malware label as a grayware label. Each of the updated labels 108 can indicate a number of malicious flags that were triggered during scanning of a corresponding HTML document. The model trainer 101 can remove grayware labeled samples from the initial training data 102 having a number of malicious flags below a threshold number of malicious flags.

At stage C, the model trainer 101 collects the refined training data 104A from the trusted data source(s) 106. The trusted data source(s) 106 can comprise one or more proprietary data sources that identify grayware campaigns, for instance one or more cybersecurity systems. These proprietary data sources can detect grayware campaigns using signatures applied to HTML documents and/or HTTP responses, and the signatures can be constructed by domain-level experts. Due to the difficulty in identifying grayware campaigns, the refined training data 104A may have fewer samples (e.g., an order of magnitude fewer samples) than the initial training data 102. Benign samples in the refined training data 104A comprise benign samples included in the initial training data 102 (e.g., samples collected from most popular websites and trusted customer websites).

At stage D, the clustering model 103 clusters grayware samples in the refined training data 104A. The clustering model 103 generates embeddings of HTML documents for the grayware samples and applies a clustering algorithm (e.g., the k-means clustering algorithm, a hierarchical clustering algorithm, Density-Based Spatial Clustering of Applications with Noise, etc.) to obtain grayware clusters 110. The clustering model 103 can use the elbow method for determining an optimal number of clusters in the grayware clusters 110. A labeling expert 105 then identifies those of the grayware clusters 110 that have a high likelihood of corresponding to grayware. In FIG. 1, the cluster comprising dashed lines was determined by the labeling expert 105 as having a low likelihood of corresponding to grayware, whereas the cluster comprising solid lines was determined by the labeling expert 105 as having a high likelihood of corresponding to grayware.

The labeling expert 105 can manually inspect HTML documents in the grayware clusters 110 and/or render the HTML documents in an isolated environment and inspect the renderings using domain-level knowledge to identify those of the grayware clusters 110 having a high likelihood of corresponding to grayware. For large clusters, HTML documents can be subsampled within each cluster prior to manual inspection by the labeling expert 105. In some embodiments, a classifier can be used to identify grayware clusters by assigning grayware or benign verdicts to HTML documents therein, with clusters having a threshold percentage (e.g., 80%) of grayware verdicts being identified as grayware clusters. Embeddings of HTML documents used by the clustering model 103 can comprise natural language embeddings (e.g., word2vec, doc2vec, etc.) that preserve semantic similarity of samples in the embeddings. As a preprocessing step, the clustering model 103 can extract text from each HTML document included between paragraph HTML tags and generate embeddings from the extracted text. Additionally or alternatively, the clustering model 103 can generate Document Object Model (DOM) embeddings of HTML documents (e.g., using flattened DOM representations) for clustering.

At stage E, the clustering model 103 updates the refined training data 104A by removing clusters identified by the labeling expert 105 as having a low likelihood of corresponding to grayware to obtain the refined training data 104B. The refined training data 104B is even more refined than the refined training data 104A by comprising trusted training data that is further refined via cluster removal. The model trainer 101 then stores the initial training data 102 and the refined training data 104B for subsequent training.

FIG. 2 is a schematic diagram of an example system for training a grayware classification model with transfer learning and initial and refined training data. FIG. 2 depicts the model trainer 101, the initial training data 102, and the refined training data 104B referred to above in reference to FIG. 1. During the training operations depicted in FIG. 2, the initial training data 102 and the refined training data 104B can be separated into training data and validation data. The split between training data and validation data can be determined using techniques such as cross-validation. The model trainer 101 uses the initial training data 102 to train a baseline grayware classification model (“baseline model”) 203, replaces a classification head of the baseline grayware classification model 203 to obtain a refined grayware classification model (“refined model”) 209, then further trains the refined model 209 (i.e., using transfer learning) on the refined training data 104B.

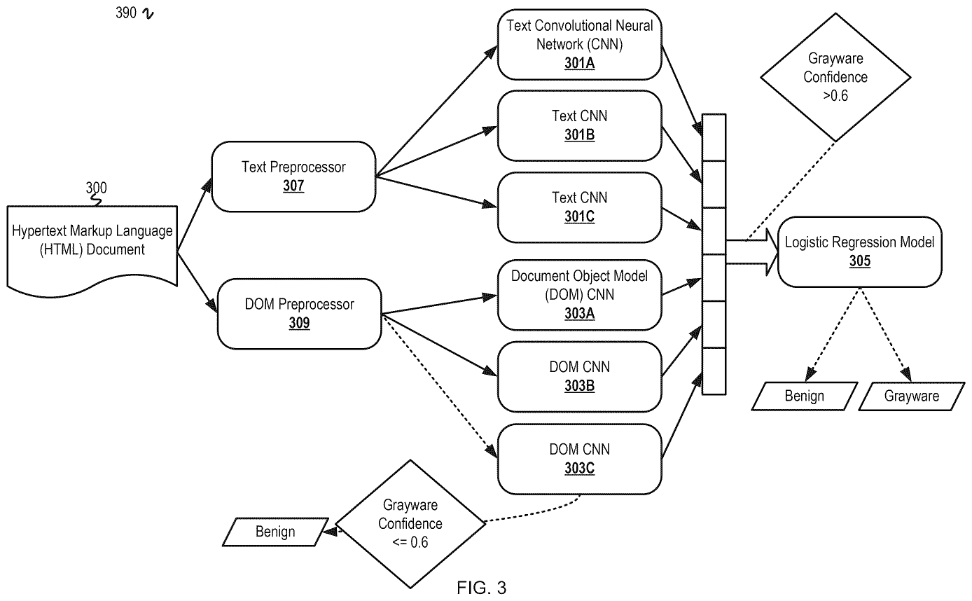

At stage A, the model trainer 101 trains the baseline model 203 on the initial training data 102 to classify HTML documents as grayware or benign. First, the model trainer 101 initializes internal parameters of the baseline model 203. For embodiments where the baseline model 203 comprises an ensemble, each model in the ensemble can be initialized with a different random seed. The architecture of the baseline model 203 comprises baseline layers 205 and subsequently a first classification head 207. FIG. 3 provides an example schematic diagram of a more detailed model architecture for the baseline model 203 and the refined model 209. The model trainer 101 trains the baseline model 203 on the initial training data 102 in batches/epochs until training termination criteria are satisfied (e.g., a threshold number of batches/epochs have occurred, training/validation error is sufficiently low, internal parameters of the baseline model 203 are converging across training iterations, etc.). Training criteria reference in the remainder can be any combination of these criteria. Although labels in the initial training data 102 may be malicious or benign labels (e.g., malicious labels obtained from third-party scanning services), a “malicious” label is treated as a grayware label for the purposes of training the baseline model 203 to classify grayware.

At stage B, the model trainer 101 replaces the first classification head 207 in the baseline model 203 with a second classification head 213 to obtain the refined model 209. The refined model 209 comprises refined layers 211 that, prior to training, have parameters and architecture identical to the baseline layers 205 after training occurs for the baseline model 203. The model trainer 101 “freezes” internal parameters of the baseline layers 205 when replacing the first classification head 207 with the second classification head 213 to obtain the refined model 209, then unfreezes these layers during training of the refined model 209.

At stage C, the model trainer 101 further trains the refined model 209 on the refined training data 104B to classify HTML documents as grayware or benign. Training occurs until training criteria for the refined model 209 are satisfied. The training criteria can be satisfied at a fewer number of iterations compared to training criteria for the baseline model 203 because the refined model 209 is trained on a smaller dataset.

FIG. 3 is a schematic diagram of an example model architecture for a grayware classification model. For instance, the depicted model architecture can comprise an architecture for any of the baseline or refined grayware classification models described herein. A grayware classification model 390 comprises, at an input layer, a text preprocessor 307 and a DOM preprocessor 309 that each receive an HTML document 300 as input. The text preprocessor 307 extracts and embeds text from the HTML document 300 (e.g., by extracting text included in header HTML elements, paragraph HTML elements, title HTML elements, etc. and applying natural language processing (NLP) embeddings such as word2vec to the extracted text). The DOM preprocessor 309 and/or the text preprocessor 307 extracts a flattened representation from the HTML document 300 and generate respective DOM and text embeddings (e.g., NLP embeddings) using the flattened representation. An example HTML document comprises the following text:
<html>

```
<head>
  <title>Free iPad!</title>
<script>
alert( );
</script>
</head>
<body>
  <h1>Congratulations! You just won a free iPad!</h1>
  <p>Click on the button below to redeem your free gift.</p>
<a href = http://www.example.com>Redeem Gift </a>
</body>
</html>
```

For the above example HTML document, the DOM preprocessor 309 extracts the HTML tags without any intervening text and generates an embedding of the extracted HTML tags. The embedding generated by the DOM preprocessor 309 is thus an embedding of the text:

<html>
<head>
<title> </title>
<script> </script>
</head>
<body>
<h1> </h1>
<p> </p>
<a> </a>
</body>
</html>

By contrast, the text preprocessor 307 extracts and embeds text from the above HTML document. In this example, the text embedding is generated from the text “Congratulations! You just won a free iPad! Click on the button below to redeem your free gift.” In this example, the script included in the script tag is not used when generating the text embedding.

The architecture of the grayware classification model 390 further comprises text convolutional neural networks (CNNs) 301A, 301B, and 301C that each receive output of the text preprocessor 307 and DOM CNNs 303A, 303B, and 303C that each receive output of the DOM preprocessor 309. During initialization prior to training, internal parameters for each of the models 301A-301C, 303A-303C can be generated with a distinct random seed. For efficiency, before inputting outputs of the text preprocessor 307 and the DOM preprocessor 309 to the models 301A-301C and 303A-303B, the model architecture inputs a DOM embedding generated by the DOM preprocessor 309 into the DOM CNN 303C. If the DOM CNN 303C outputs a confidence value for the HTML document 300 being grayware less than or equal to a threshold confidence value (depicted as 0.6 in FIG. 3 as an illustrative example), the model 390 assigns a benign verdict to the HTML document 300 without invoking the remaining models 301A-301C, 303A-303B. Due to the high frequency of benign classifications in practice, this prefiltering of HTML documents having high confidence benign verdicts using only one model rather than a full ensemble represents a significant improvement in efficiency (e.g., an order of magnitude when the ensemble has many models). While this step is optional, it does not significantly impact overall classification accuracy. In embodiments, any model or subset of models can be used for prefiltering HTML documents having high confidence benign verdicts, for instance any combination of the models 301A-301C, 303A-303C.

If the confidence value output by the DOM CNN 303C is above the threshold confidence value (0.6 in this example), the grayware classification model 390 invokes the text CNNs 301A-301C on a text embedding output by the text preprocessor 307 and invokes the DOM CNNs 303A-303B to obtain a tuple of six confidence values. A classification head for the model 390 (e.g., the first classification head 207 or the second classification head 213 depicted above in reference to FIG. 2) comprises a logistic regression model 305 that takes the tuple of six confidence values as input and outputs a confidence value indicating malicious or grayware verdict. Model architecture for grayware classification models described herein can vary in number and type of internal layers/models, preprocessing types and embeddings generated thereof, types of classification heads, etc.

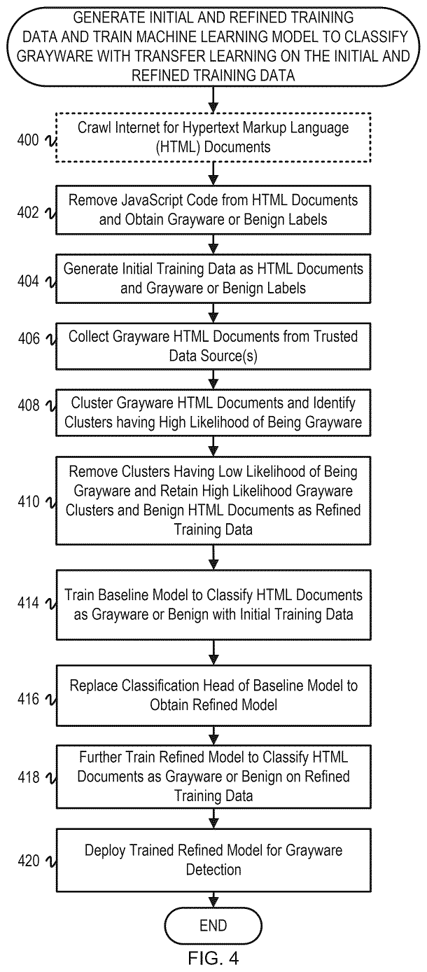

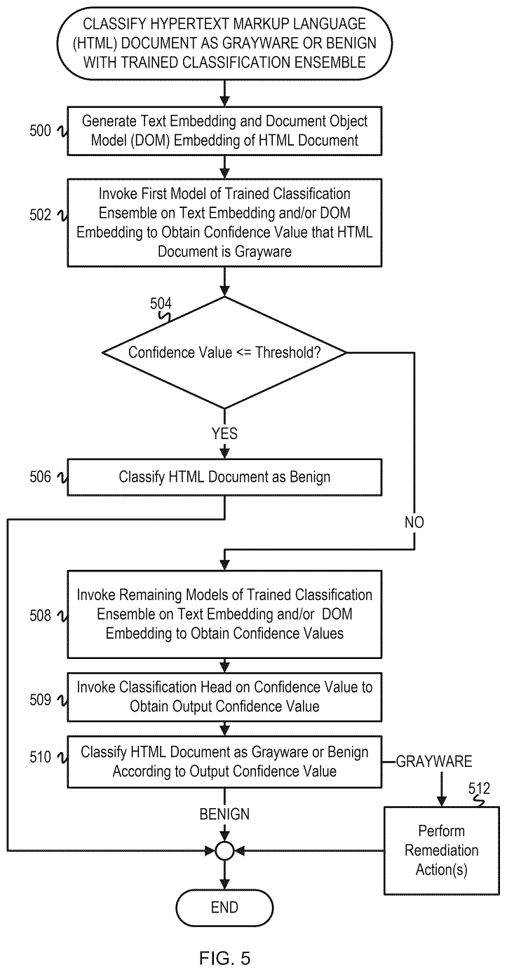

FIGS. 4 and 5 are flowcharts of example operations. The example operations are described with reference to a model trainer, a baseline grayware classification model (“baseline model”), a refined grayware classification model (“refined model”), and a clustering model for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations for generating initial and refined training data and training a machine learning model to classify grayware with transfer learning on the initial and refined training data. At block 400, the model trainer crawls the Internet for HTML documents. The model trainer comprises a web crawler that can be a component of a larger cybersecurity system crawling the Internet to detect malicious websites for URL filtering. Block 400 is depicted with a dashed outline to indicate that websites can be continuously crawled for HTML documents that are stored in a centralized repository (e.g., for cybersecurity) independently of the remaining operations in FIG. 4 that are triggered when a grayware classification model is to be trained. For benign HTML documents, the model trainer can crawl top-N websites according to a popularity ranking (e.g., the Tranco list) and/or can crawl trusted customer websites known to be benign.

At block 402, the model trainer removes JavaScript code from the HTML documents and obtains grayware or benign labels. For instance, the model trainer can remove script tags from the HTML documents. The grayware or benign labels can be obtained from a third-party scanning service used to scan the HTML documents (with any JavaScript code removed) to obtain malicious or benign labels. For subsequent purposes of training grayware classification models, a “malicious” label is treated as a “grayware” label, although a malicious labeled HTML document may have a low likelihood of corresponding to grayware. The third-party scanning service can, in addition to assigning malicious or benign labels, communicate one or more malicious triggers or flags identified during scanning. In some embodiments, the model trainer can remove HTML documents having a number of malicious triggers or flags below a threshold so as to retain only HTML documents having a high confidence of being malicious. The model trainer may only use the scanning service for generating malicious/grayware labels and not for generating benign labels, and any HTML documents not crawled from high popularity or trusted websites that are assigned benign labels by the scanning service can be discarded.

At block 404, the model trainer generates the initial training data as the HTML documents and corresponding grayware or benign labels. The model trainer stores the initial training data for subsequent model training.

At block 406, the model trainer collects grayware HTML documents from a trusted data source(s). For instance, the trusted data source(s) can comprise one or more third-party scam cataloging feeds, grayware campaign detections by a cybersecurity service or other trusted and/or proprietary service, manually identified grayware campaigns from customer data, etc. There may be an order or several orders of magnitude less grayware HTML documents collected from the trusted data source(s) than the HTML documents crawled from the Internet at block 400.

At block 408, the clustering model generates embeddings of the grayware HTML documents and clusters the embeddings of the grayware HTML documents. An expert then manually inspects and identifies clusters having a high likelihood of comprising grayware HTML documents. The clustering model can generate text and/or DOM embeddings of the grayware HTML documents prior to clustering and can applying a clustering algorithm to generate the clusters such as the k-means clustering algorithm.

At block 410, the clustering model removes clusters (after manual inspection from an expert) having low likelihood of comprising grayware HTML documents and retains HTML documents in the high likelihood grayware clusters and benign HTML documents as the refined training data. The clustering model can discard a percentage of the benign HTML documents so that the ratio of grayware to benign HTML documents is the same as the ratio in the initial training data. Identification of clusters having a low likelihood/confidence of comprising grayware HTML documents can be by the expert and/or can be based on obtaining grayware/benign verdicts from HTML documents with a classifier (even if the classifier is not accurate) and discarding clusters having a percentage of grayware verdicts below a threshold (e.g., less than 80 or 90%).

At block 414, the model trainer trains the baseline model to classify HTML documents as grayware or benign with the initial training data until training criteria are satisfied. At block 416, the model trainer replaces the classification head of the baseline model to obtain the refined model. Internal parameters of the baseline model apart from the classification head remain fixed during replacement of the classification head. At block 418, the model trainer further trains (i.e., using transfer learning) the refined model to classify HTML documents as grayware or benign on the refined training data until training termination criteria are satisfied. The initial and refined training data can be split into training data and validation data (e.g., using cross-validation) during training.

At block 420, the model trainer deploys the trained refined model for grayware detection. For instance, the trained refined model can be deployed at a web crawling component of a cybersecurity system to analyze HTML documents crawled from the Internet for grayware. Grayware verdicts output by the trained refined model can be associated with the corresponding website and/or URL in a URL filtering system or other cybersecurity system.

FIG. 5 is a flowchart of example operations for classifying HTML documents as grayware or benign with a trained classification ensemble. The trained classification ensemble can comprise the refined grayware classification models trained with transfer learning on initial and refined training data described in the foregoing. The trained classification ensemble is assumed to have an input layer comprising a text preprocessor and a DOM preprocessor, at least two subsequent models, and a classification head that takes outputs of the at least two subsequent models as input to generate output confidence values used to obtain benign or grayware verdicts. The operations in FIG. 5 assume that an HTML document has been obtained for grayware detection. For instance, the HTML document can be obtained from a web crawler crawling the Internet to detect malicious websites and the grayware detection can be part of a larger malware detection pipeline.

At block 500, the trained classification ensemble generates a text embedding and a DOM embedding of an HTML document. For instance, the trained classification ensemble can extract text from paragraph tags, header tags, title tags, etc. and apply an NLP embedding to the extracted text to generate the text embedding. The trained classification ensemble can extract a flattened DOM representation and apply an NLP embedding to the flattened DOM representation to generate the DOM embedding.

At block 502, the trained classification ensemble invokes a first of the at least two models on the trained text embedding and/or the DOM embedding (based on model architecture) to obtain a confidence value that the HTML document is grayware. The first model can comprise a CNN. In some embodiments, any subset of models in the trained classification ensemble can be invoked.

At block 504, the trained classification ensemble determines whether the confidence value output by the first model is less than or equal to a threshold confidence value (e.g., 0.6). If the confidence value is less than or equal to a threshold confidence value, operational flow proceeds at block 506. Otherwise, operational flow proceeds at block 508.

At block 506, the trained classification ensemble classifies the HTML document as benign. Due to the benign verdict, no remediation action is needed and the operational flow in FIG. 5 terminates. The operations at blocks 502, 504, and 506 improve efficiency of the trained classification ensemble because a high frequency of HTML documents are benign, therefore prefiltering benign HTML documents by only invoking a first or subset of models avoids invoking the full trained classification ensemble on every input.

At block 508, the trained classification ensemble invokes the remaining of the at least two models on the text embedding and/or the DOM embedding to obtain one or more confidence values. Each of the remaining models is configured to take at least one of the text embedding and the DOM embedding as input according to the architecture of the trained classification ensemble.

At block 509, the trained classification ensemble invokes its classification head on the confidence values obtained from invoking the first model and remaining models to obtain an output confidence value. For instance, the classification head can comprise a logistic regression model. At block 510, the trained classification ensemble then classifies the HTML document as benign or grayware according to the output confidence value, e.g., as benign if the output confidence value is below an (additional) threshold confidence value and as grayware otherwise. If the trained classification ensemble classifies the HTML document as benign, the operational flow in FIG. 5 terminates. Otherwise, the operational flow proceeds to block 512.

At block 512, the trained classification ensemble or other cybersecurity component performs a remediation action(s) based on the grayware verdict. For instance, the trained classification ensemble can block or more closely monitor network traffic from a website corresponding to the HTML documents. The trained classification ensemble can add URLs of the website to a list of URLs for URL filtering, can forward indications of the website to an expert for analysis of a corresponding grayware campaign, can scan endpoint devices that communicated with the website for any installed grayware (e.g., browser extensions, PUPs, etc.) etc.

### Variations

The foregoing refers to collecting initial training data from initial data sources and at least partially labeling the initial training data with verdicts from file scanning services, then collecting refined training data from trusted data sources and improving the refined training data with clusters and high confidence grayware cluster identification. Other methods of obtaining initial training data and refined training data for training a baseline and refined model, respectively, during transfer learning are anticipated. For instance, the refined training data can be generated from the initial training data using clustering and grayware campaign identification. The architecture of the baseline and refined models can vary from the architectures depicted in the foregoing-any classification model architecture including a classification head may be used.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, with respect to FIG. 5, performing a streamlined benign classification with one model of an ensemble of models is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

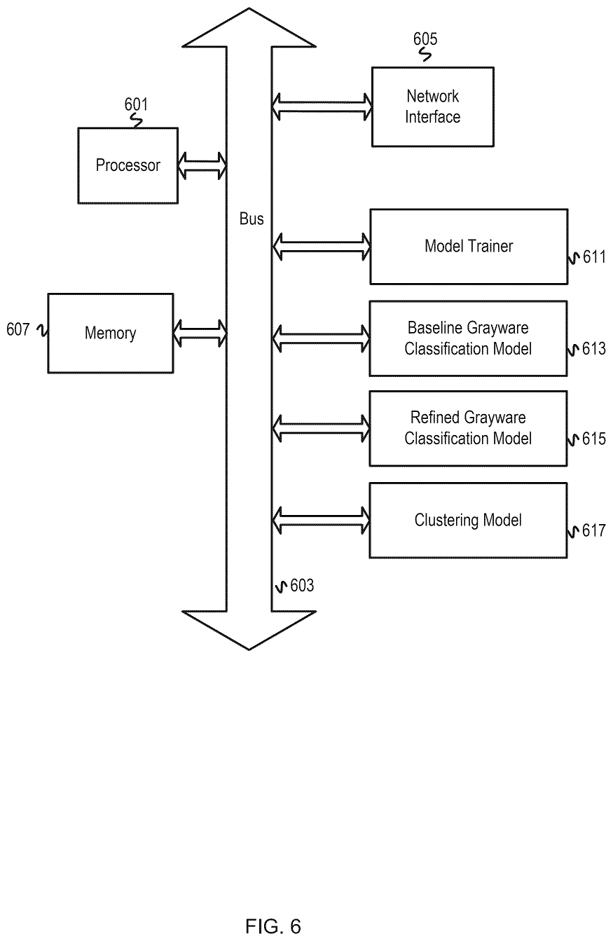

FIG. 6 depicts an example computer system with a model trainer, a baseline grayware classification model, a refined grayware classification model, and a clustering model. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a model trainer 611, a baseline grayware classification model (“baseline model”) 613, a refined grayware classification model (“refined model”) 615, and a clustering model 617. The model trainer 611 collects initial training data by crawling the Internet for HTML documents and obtains grayware or benign verdicts for the initial training data at least partially using one or more file scanning services. The model trainer 611 then collects refined training data from one or more trusted data sources. The clustering model 617 embeds and clusters grayware samples in the refined clustering data with a clustering algorithm and then identifies and removes those clusters having low confidence of comprising grayware. The model trainer 611 trains the baseline model 613 to classify HTML documents as grayware or benign with the initial training data until training criteria are satisfied. The model trainer 611 replaces a classification head of the baseline model 613 to obtain the refined model 615 and further trains the refined model 615 to classify HTML documents as grayware or benign using transfer learning. Although depicted as communicatively coupled to the bus 603, any of the model trainer 611, the baseline model 613, the refined model 615, and the clustering model 617 can be components of distinct computing systems and, in some embodiments, can be accessed via application programming interfaces (APIs) such as when a model is hosted in the cloud. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
training a first machine learning model to detect grayware websites with first training data;
replacing a first classification head of the trained first machine learning model with a second classification head to obtain a second machine learning model;
training the second machine learning model to detect grayware websites with refined training data; and
deploying the trained second machine learning model for detecting grayware websites.

2. The method of claim 1, wherein inputs to the first machine learning model and the second machine learning model comprise text embeddings and Document Object Model embeddings generated from first samples in the first training data and second samples in the refined training data, respectively.

3. The method of claim 2, wherein the text embeddings and Document Object Model embeddings are generated based on Hypertext Markup Language documents indicated in the first samples of the first training data.

4. The method of claim 1, wherein the first machine learning model and the second machine learning model comprise an ensemble of a plurality of convolutional neural networks and a logistic regression model.

5. The method of claim 4, wherein deploying the trained second machine learning model for detecting grayware websites comprises,
inputting a sample corresponding to a website into a first of the plurality of convolutional neural networks to obtain a confidence value that the website is grayware; and
based on the confidence value being below a threshold confidence value, determining that the website is not grayware.

6. The method of claim 1, wherein the refined training data comprises at least one cluster of the second training data labeled as grayware.

7. The method of claim 6, further comprising obtaining the refined training data, wherein obtaining the refined training data comprises,
clustering third samples that are likely to correspond to grayware to obtain one or more clusters; and
identifying those of the one or more clusters that correspond to known grayware campaigns, wherein the refined training data comprises the second samples in clusters identified as corresponding to known grayware campaigns.

8. The method of claim 1, wherein deploying the trained second machine learning model for detecting grayware websites comprises,
crawling the Internet for fourth samples corresponding to potentially grayware websites; and
inputting the fourth samples into the trained second machine learning model to obtain confidence values that each of the potentially grayware websites is grayware or benign.

9. A non-transitory machine-readable medium having program code stored thereon, the program code comprising instructions to:
train a first machine learning model and a second machine learning model to detect grayware Hypertext Markup Language (HTML) documents on first training data and second training data with transfer learning, wherein the instructions to train the first machine learning model and the second machine learning model comprise instructions to,
train the first machine learning model to classify HTML documents as grayware or benign with the first training data;
replace a first classification of the trained first machine learning model with a second classification head to obtain the second machine learning model;
train the second machine learning model to classify HTML documents as grayware or benign with the second training data; and
deploy the second machine learning model for detecting grayware.

10. The non-transitory machine-readable media of claim 9, wherein the second training data comprises refined training data having grayware labeled samples therein with high likelihoods of corresponding to known grayware campaigns.

11. The non-transitory machine-readable media of claim 10, wherein the program code further comprises instructions to obtain the refined training data, wherein the instructions to obtain the refined training data comprise instructions to,
cluster samples of the refined training data that are likely to correspond to grayware to obtain one or more clusters;
identify those of the one or more clusters that correspond to known grayware campaigns; and
remove, from the refined training data, those of the one or more clusters that do not correspond to know grayware campaigns.

12. The non-transitory machine-readable media of claim 9, wherein input layers of the first machine learning model and the second machine learning model generate text embeddings and Document Object Model embeddings of HTML documents.

13. The non-transitory machine-readable media of claim 9, wherein the first machine learning model and the second machine learning model comprise an ensemble of a plurality of convolutional neural networks and a logistic regression model.

14. The non-transitory machine-readable media of claim 13, wherein the instructions to deploy the trained second machine learning model for detecting grayware websites comprise instructions to,
input a sample corresponding to a website into a first of the plurality of convolutional neural networks to obtain a confidence value that the website is grayware; and
based on the confidence value being below a threshold confidence value, determine that the website is not grayware.

15. An apparatus comprising:
a processor; and
a machine-readable medium having instructions stored thereon that are executable by the processor to cause the apparatus to,
train a first machine learning model to detect grayware websites with first training data;
replace a first classification head of the trained first machine learning model with a second classification head to obtain a second machine learning model;
train the second machine learning model to detect grayware websites with second training data, wherein the second training data comprises second samples associated with known grayware campaigns; and
deploy the trained second machine learning model for detecting grayware websites.

16. The apparatus of claim 15, wherein inputs to the first machine learning model and the second machine learning model comprise text embeddings and Document Object Model embeddings generated from first samples in the first training data and second samples in the second training data, respectively.

17. The apparatus of claim 16, wherein the text embeddings and Document Object Model embeddings are generated based on Hypertext Markup Language documents indicated in the first samples of the first training data.

18. The apparatus of claim 15, wherein the first machine learning model and the second machine learning model comprise an ensemble of a plurality of convolutional neural networks and a logistic regression model.

19. The apparatus of claim 18, wherein the instructions to deploy the trained second machine learning model for detecting grayware websites comprise instructions executable by the processor to cause the apparatus to,
input a sample corresponding to a website into a first of the plurality of convolutional neural networks to obtain a confidence value that the website is grayware; and
based on the confidence value being below a threshold confidence value, determine that the website is not grayware.

20. The apparatus of claim 15, wherein the second training data comprises at least one cluster of the second samples labeled as grayware, wherein the machine-readable medium further has stored thereon instructions executable by the processor to cause the apparatus to:
cluster third samples that are likely to correspond to grayware to obtain one or more clusters; and
identify those of the one or more clusters that correspond to known grayware campaigns, wherein the second training data comprises the second samples in clusters identified as corresponding to known grayware campaigns.
